(19) United States
(12) Patent Application Publication
(10) Pub. No.: US 2003/0020024 A1
(43) Pub. Date: Jan. 30, 2003

(54) Method for creating pores and microporous film

(76) Inventors: Etienne Ferain, Masnuy Saint Jean (BE); Roger Legras, Lens-Saint-Remy (BE); Henri Hanot, Saint-Denis (BE)

Correspondence Address: HARNESS, DICKEY & PIERCE, P.L.C., P.O. BOX 828, BLOOMFIELD HILLS, MI, 48303, US

(21) Appl. No.: 10/184,506

(22) Filed: Jun. 27, 2002

Related U.S. Application Data
(63) Continuation of application No. PCT/EP00/13407, filed on Dec. 29, 2000.

(30) Foreign Application Priority Data
Dec. 29, 1999 (FR) 99/16656
Dec. 29, 2000 (WO) PCT/EP00/13407

(51) Int. Cl. C03C 25/68; B44C 1/22

(52) U.S. Cl. 250/492.1; 216/56; 216/66

(57) ABSTRACT

The invention relates to a method for creating pores in a sheet polymer material. The invention more particularly relates to a method for creating nanoscale pores, typically of the order of less than 200 nm, in a polymer material such as sheet polycarbonate or any other equivalent material.

The invention relates to a method for creating pores in a sheet polymer material. The invention more particularly relates to a method for creating nanoscale pores, typically of the order of less than 200 nm, in a polymer material such as sheet polycarbonate or any other equivalent material.

There are already known, in the prior art, various methods for creating pores of small cross-section in sheets of polymer material, for example with a view to producing microporous membranes for the purification or filtration of industrial or biological fluids, or for water treatment. These methods can be grouped together according to three major types:

a first, mechanical, type of method comprising at least one stamping step, as described for example in the document U.S. Pat. No. 4,652,412;

a second type of method, comprising at least one irradiation using a CO₂ or NdYAG infrared laser or pulsed laser, as described for example in the documents U.S. Pat. Nos. 4,923,608, 3,742,182, WO-A-98 30317;

a third type of method, comprising at least one ion irradiation followed by a chemical etching.

The method according to the invention for creating pores in a material such as sheet polycarbonate belongs to the third general type presented above. For this type of pore creation method, with a view to producing filtration membranes, reference can be made for example to the following documents: DE-A-4 319 610, U.S. Pat. Nos. 5,234,538, 3,713,921. The document U.S. Pat. No. 4,956,219, from the applicant, describes a method for creating pores in a material chosen from amongst the group comprising saturated polyesters such as ethylene polyterephthalate, carbonic acid polyesters such as polycarbonate produced from bis-phenol A (bis(hydroxy-4 phenol)-2,2 propane), aromatic polyethers, polysulphones, polyolefins, cellulose acetates and cellulose nitrates. The material is irradiated by a beam of ions preferably issuing from rare gases such as argon, with an energy of around 2 MeV per nucleon, the beam having an intensity of between 10⁶ and 10¹³ ions per second. Such beams can be obtained by means of particle accelerators such as cyclotrons with separate sectors. The material is in the form of a strip moving in front of a beam of ions, the thickness of the strip being from around a few microns to 100 microns, the width of the strip being between 5 and 150 centimeters. By magnetic deflection, the beam of ions effects a sinusoidal sweep, each portion of the strip being irradiated on several occasions so that an even density of pores is obtained over the entire strip of material treated. After irradiation, the strip of material is possibly subjected to ultraviolet (UV) radiation. After this UV treatment or directly after ion bombardment, a chemical treatment is effected in a corrosive solution containing an organic solvent. Thus, for example, the strip of material is immersed in a solution of caustic soda containing methanol, ethanol or isopropanol. One or more steps of the method can be carried out continuously, possibly directly after each other, the strip of material which is passed opposite the beam being driven continuously in the corrosive solution. After neutralisation, rinsing and drying, a continuous strip of microporous polymer material is obtained.

The document U.S. Pat. No. 3,852,134 describes a method for the ion bombardment of polycarbonate film with a thickness of less than twenty microns, followed by exposure to radiation with a wavelength of less than 4000 angstroms, under oxygen, before a first chemical etching, baking and second chemical etching with a view to obtaining pores with diameters of between 1000 and 100,000 angstroms. The preferential etching methods in directions defined by molecular structure defects resulting from an ion bombardment make it possible to produce filtering membranes with a greater quality than the membranes resulting from other methods such as stamping or laser treatment. However, controlling the density, shape and size of the pores obtained is still tricky. Thus it has been found that the pores are of variable diameter from the surface towards the heart of the membrane, thus having a “cigar” shape (for polycarbonate membranes, see Schonenberger et al., J. Phys. Chem. B101, p. 5497-5505, 1997). This in particular interferes with a good prediction of the properties of these membranes merely by looking at their surface, for example with a scanning electron microscope. The cause of this shape of the pores is still being discussed.

The document U.S. Pat. No. 3,713,921 presents the use of a surfactant added to the etching reagent in order to attenuate these variations in shape and transverse dimension of the pores. Some authors invoke an influence of the thickness of the membrane and imperfect control of the etching conditions in order to explain the “cigar” shape of the pores.

The invention relates to a method for creating pores in a sheet polymer material, such as polycarbonate or any other equivalent material, the said method making it possible to obtain pores with a cylindrical shape overall and smooth, without any appreciable variation in average diameter of these pores in the thickness of the sheets of polymer material treated. The invention also concerns the microporous membranes produced from the said treated sheets of polymer material.

The invention relates, according to a first aspect, to a method for creating smooth cylindrical nanoscale pores in a sheet polymer material comprising an ion bombardment, a possible UV treatment and chemical etching, the said method comprising pre-etching carried out prior to the ion bombardment, a pre-etching reducing the thickness of the sheet of polymer material. The polymer material is chosen from the group comprising saturated polyesters such as ethylene polyterephthalate, carbonic acid polyesters such as polycarbonate produced from bis-phenol A (bis(hydroxy-4 phenol)-2,2 propane), aromatic polyethers, polysulphones, polyolefins, cellulose acetates and cellulose nitrates. The sheet of polymer material has, before pre-etching, a thickness of between a few hundreds of nanometers and around a hundred microns. For example, the pre-etching is carried out until the ablation of a thickness of as much as 3 microns approximately on each face of the said sheet.

According to a particular embodiment, the polymer material is an amorphous polycarbonate approximately 25 microns thick before pre-etching. According to another particular embodiment, the polymer material is a crystalline polycarbonate with a thickness of approximately 10 microns before pre-etching. An ultraviolet treatment is carried out after the ion bombardment and before the chemical etching. The ion bombardment is performed by a beam of ions preferably issuing from rare gases such as argon, with an energy of around 2 MeV per nucleon, the density of ions passing through the polymer film being between 10⁴ and 10¹³ ions per square centimeter.

In one embodiment, the chemical etching is said to be slow and is carried out in a bath containing caustic soda at approximately 0.5 N in aqueous solution, at a temperature of approximately 70° C., for approximately 260 min. In another embodiment, the chemical etching is said to be fast and is carried out in a bath containing caustic soda at approximately 2 N, in aqueous solution, at a temperature of approximately 70° C., for approximately 30 min. The chemical etching bath comprises, in another embodiment, an organic solvent chosen from amongst the group comprising methanol, ethanol and isopropanol. The chemical etching is carried out in the presence of a surfactant. The microporous films obtained after chemical etching are washed until the pH is neutralised, rinsed and dried. The washing of the microporous film is carried out in an aqueous solution of acetic acid at approximately 15%, at a temperature of approximately 70° C. for approximately 15 minutes, then in demineralised water, at a temperature of approximately 70° C., for approximately 15 minutes and more, until a neutral pH is obtained. The method for creating nanoscale pores is carried out continuously.

The invention relates, according to a second aspect, to a microporous film of polymer material produced by implementing the method presented above. This microporous film is used as a matrix or as a filter which can be used for various applications including the production of micrometric filaments of metal or polymer.

Other objects and advantages of the invention will emerge during the following description of embodiments, a description which will be effected with reference to the accompanying drawings, in which:

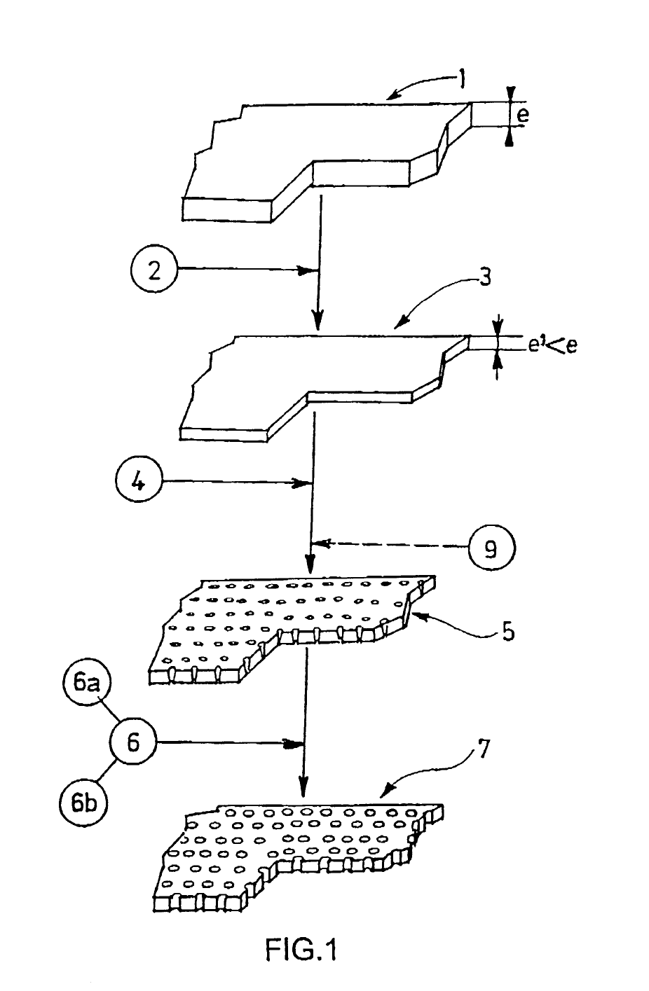

FIG. 1 is a schematic diagram depicting the successive steps of a method for creating pores in a sheet polymer material, according to a first embodiment of the invention;

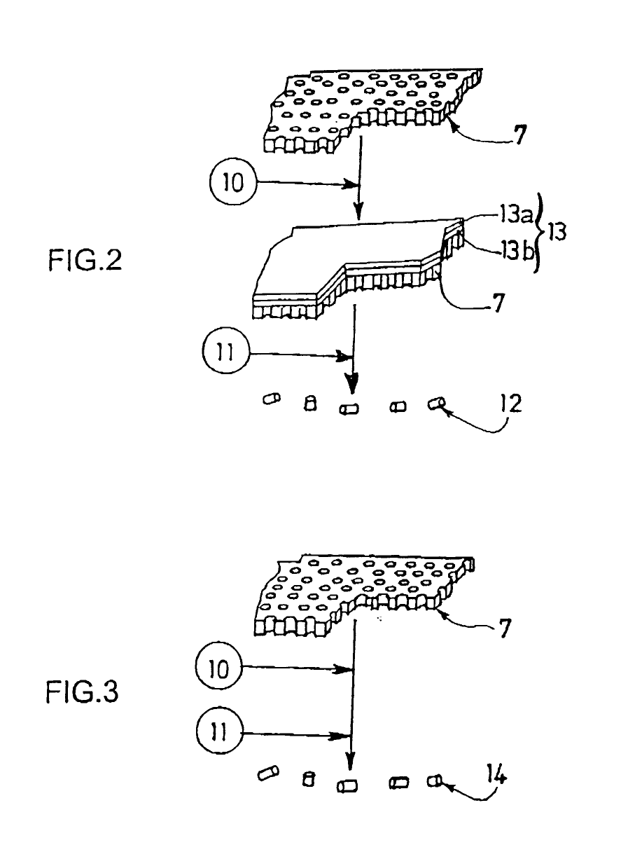

FIG. 2 is a schematic diagram depicting the successive steps of a method for manufacturing metallic filaments, a manufacturing method using the sheet polymer material treated in accordance with the pore creation method as shown schematically in FIG. 1;

FIG. 3 is a schematic diagram depicting the successive steps of a method for manufacturing polymer filaments, a manufacturing method using the sheet polymer material treated in accordance with the pore creation method as shown schematically in FIG. 1;

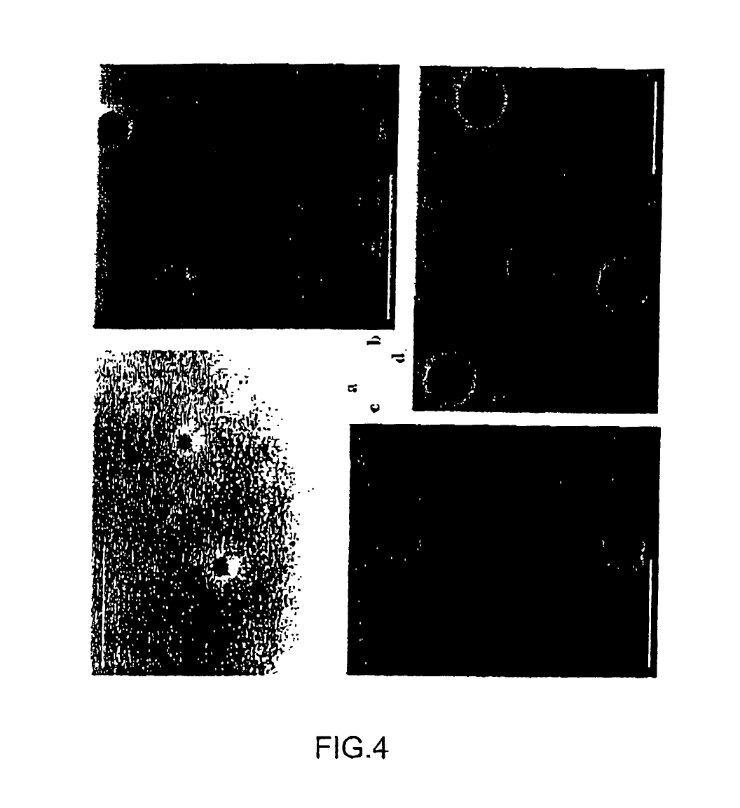

FIG. 4 is a photograph, taken with a field-effect scanning electron microscope, of the surface of a polycarbonate film treated according to the method of FIG. 1, the scale bar corresponding to a length of 200 nm;

FIG. 5 is a photograph, taken with a field-effect scanning electron microscope, of cobalt nanofilaments obtained by electrolytic deposition in the pores of a polycarbonate film according to the method shown schematically in FIG. 2, the scale bar in FIG. 5 corresponding to a length of 5 microns;

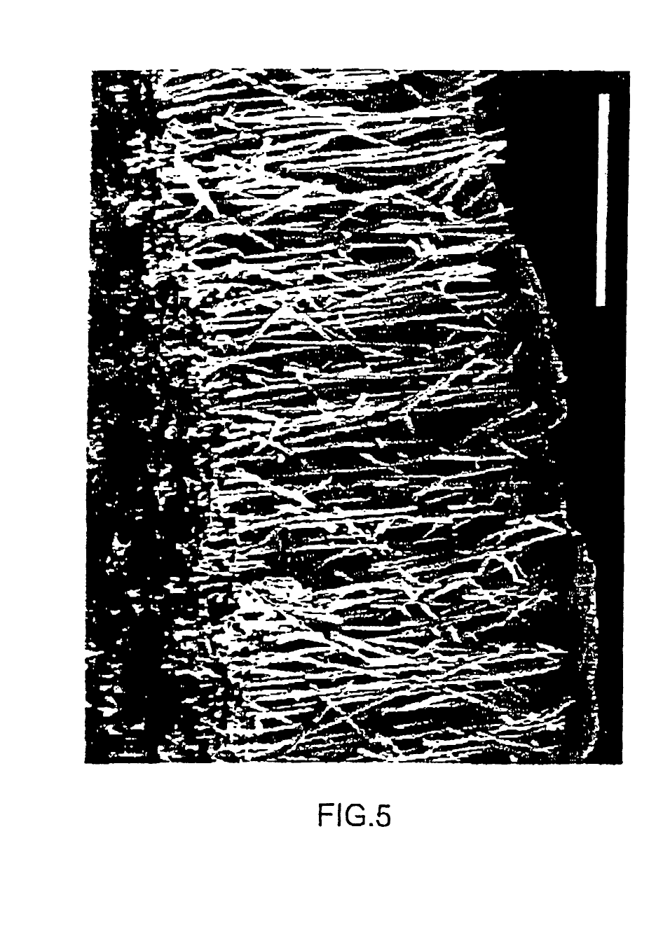

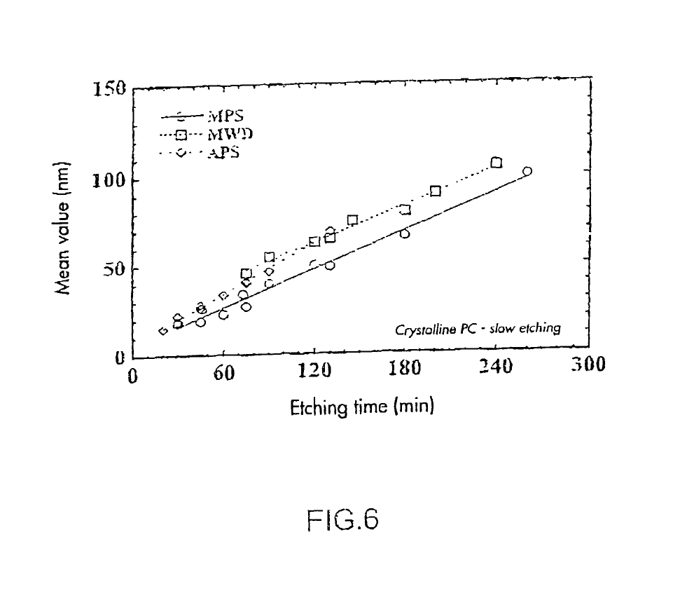

FIG. 6 is a graph showing the changes, as a function of the time of “slow” etching of films of crystalline polycarbonate, in three parameters, namely: the mean value of the diameters of the filaments in their middle part (MWD), the mean value of the diameters of the pores at their orifice (MPS), the average of the pore sizes (APS);

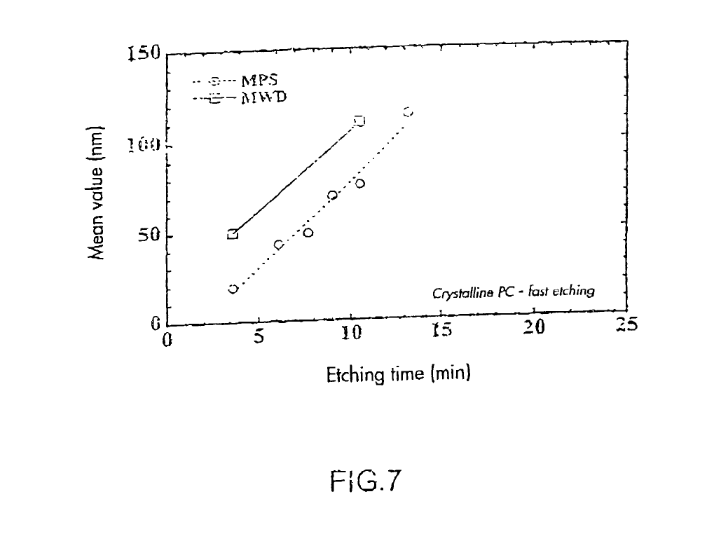

FIG. 7 is a graph depicting the changes, as a function of the “fast” etching time of crystalline polycarbonate films, in two parameters, namely: the mean value of the diameters of the pores at their orifice (MPS) and the mean value of the diameters of the filaments in their middle part (MWD);

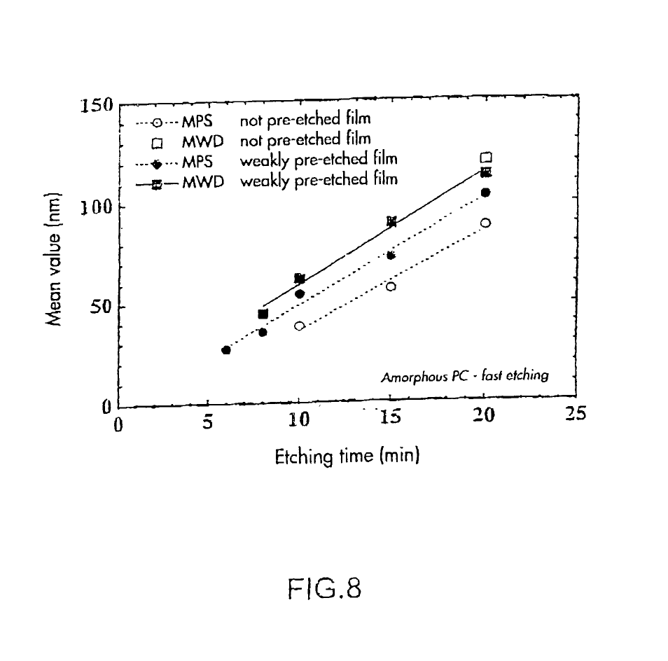

FIG. 8 is a graph depicting the changes in the parameters MPS and MWD defined above, as a function of the etching time, in the case of a “fast” etching of films of amorphous polycarbonate not pre-etched and weakly pre-etched;

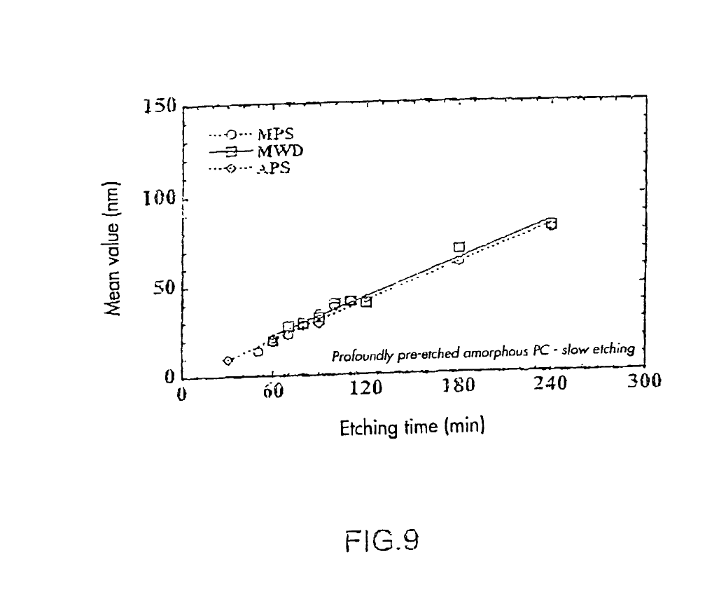

FIG. 9 is a graph depicting the changes in the parameters APS, MPS and MWD defined above, as a function of the “slow” etching time of films of amorphous polycarbonate profoundly pre-etched;

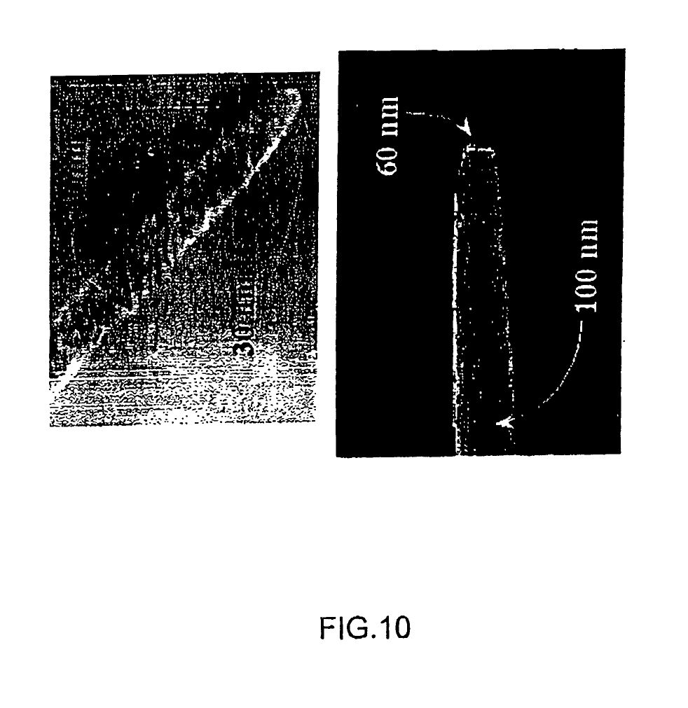

FIG. 10 is a view under the field-effect scanning electron microscope of end parts of metallic nanofilaments obtained by electrolytic deposition in a microporous film of crystalline polycarbonate, treated in accordance with the methods in FIGS. 1 and 2;

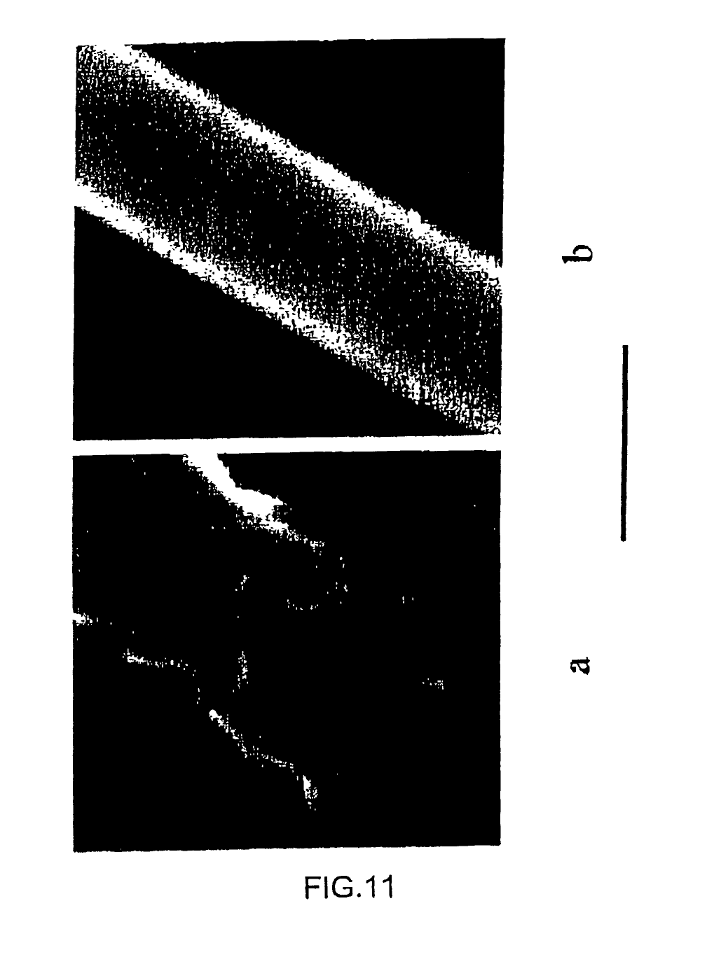

FIG. 11 contains two views under the field effect scanning electron microscope of portions of nanofilaments obtained by electrolytic deposition in a microporous film of polycarbonate, treated in accordance with the methods in FIGS. 1 and 2, in FIG. 11a from a film of crystalline polycarbonate, in FIG. 11b from a film of amorphous polycarbonate (scale bar: 5 microns);

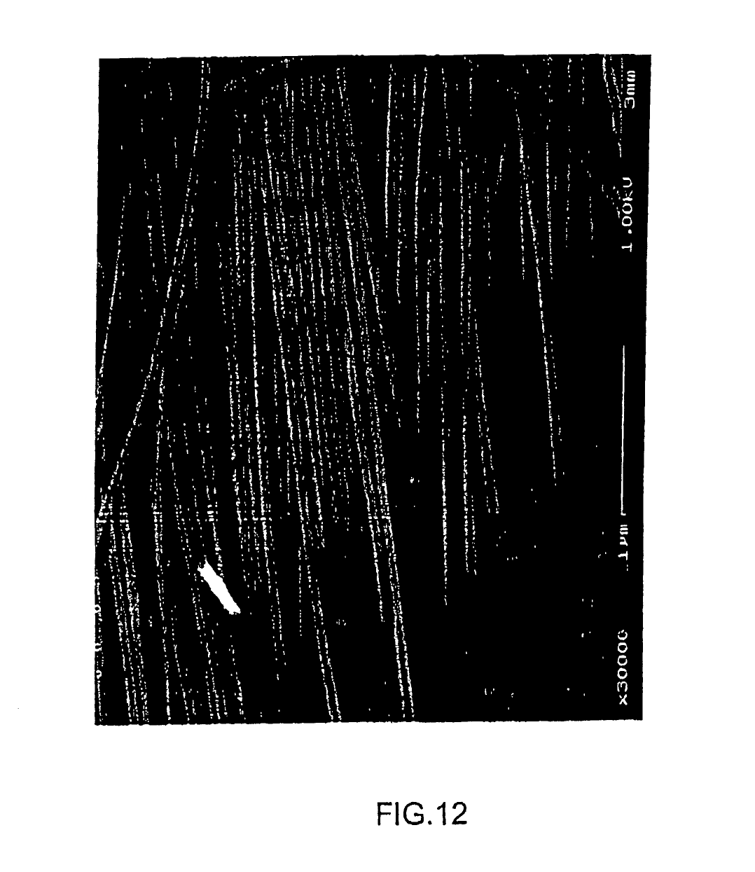

FIG. 12 is a view under the field-effect scanning electron microscope of nanofilaments of polypyrrole obtained by electrolytic deposition in a film of profoundly pre-etched amorphous polycarbonate, according to one embodiment of the method of FIG. 3.

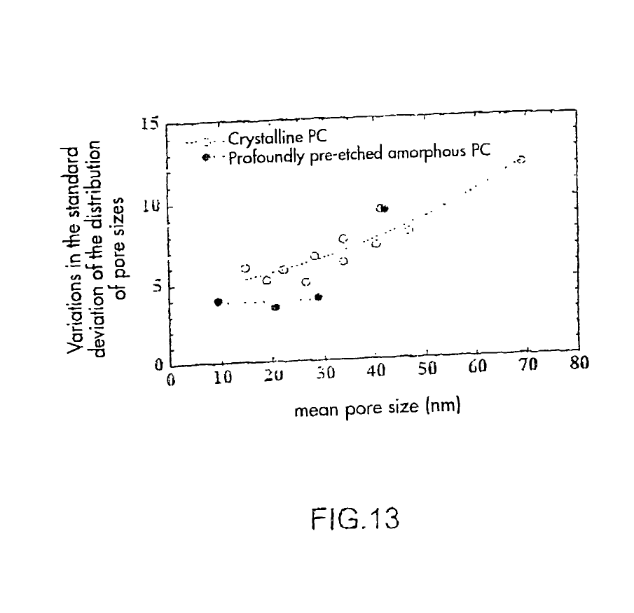

FIG. 13 is a graph showing the variations in the standard deviation of the distributions of the pore sizes for films of crystalline polycarbonate and for films of amorphous polycarbonate, greatly pre-etched;

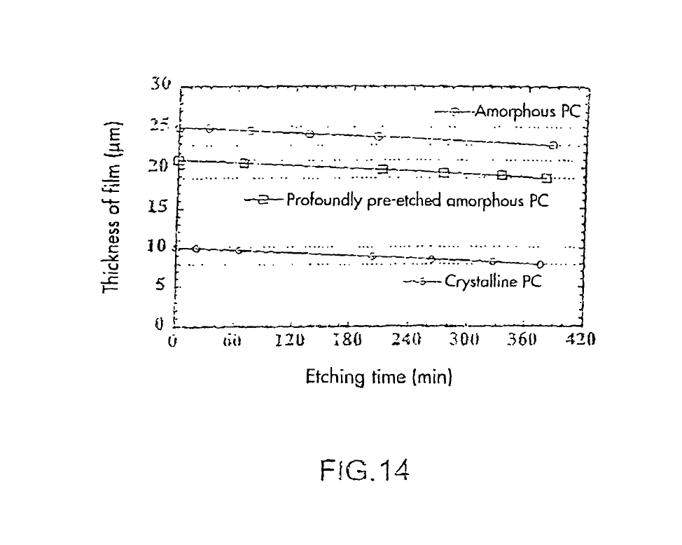

FIG. 14 is a graph showing the variations in the thickness of films not subjected to ion bombardment, as a function of the chemical etching time, the films in question being of amorphous polycarbonate, greatly pre-etched or not, or crystalline polycarbonate.

Reference is made first of all to FIG. 1. The method for creating pores in an initial polymer film 1, as shown schematically in FIG. 1, comprises three successive steps:

a chemical pre-etching 2 of the initial film 1, producing a pre-etched film 3 of thickness “e” less than that “e” of the initial film 1;

an ion bombardment 4 of the pre-etched film 3, producing an irradiated film 5;

a chemical etching 6 of the irradiated film 5.

The initial polymer film 1 can be produced from a material chosen from amongst the group comprising saturated polyesters such as ethylene polyterephthalate, carbonic acid polyesters such as polycarbonate produced from bis-phenol A (bis(hydroxy-4 phenol)-2,2 propane), aromatic polyethers, polysulphones, polyolefins, cellulose acetates and cellulose nitrates.

In the remainder of the description, only the results obtained with polycarbonate will be described. Two grades of polycarbonate produced from bis-phenol A will be considered: a crystalline polycarbonate (referred to as PCc hereinafter, for the purpose of simplification) and an amorphous polycarbonate (referred to as PCa). As PCc, a 10 micron thick film, sold under the brand name Makrofol™ by Bayer, is used in the following detailed examples. This Makrofol™ film is produced by moulding, crystallisation and longitudinal stretch forming. As PCa, a 25 micron thick film, sold under the brand name Lexan™ by General Electric, is used in the following detailed examples. Two chemical pre-etchings 2 will be considered in the examples detailed below: a “light” pre-etching referred to as Preal and an “intense” pre-etching referred to as Preai. The ion bombardment 4 is carried out, in one embodiment, by means of a beam of ions preferably issuing from rare gases such as argon, with an energy of around 2 MeV per nucleon, the beam having an intensity of between 10⁶ and 10¹³ ions per second. Such beams can be obtained by means of particle accelerators such as cyclotrons with separate sectors. The pre-etched film 3 is, in one embodiment, in the form of a strip passing substantially perpendicular to the beam of ions, the thickness of the strip being around a few hundreds of nanometers to 100 microns, the width of the strip being between 5 and 150 centimeters.

By magnetic deflection or any other equivalent method, the beam of ions effects a sweep, for example sinusoidal or square, triangular, each portion of the strip irradiated on several occasions so that a homogeneous density of pores is obtained over the entire strip of irradiated film 5. The irradiated film 5 is subjected to chemical etching 6, carried out in a corrosive solution possibly containing an organic solvent. Thus, for example, the irradiated film 5 is immersed in a solution of caustic soda containing methanol, ethanol or isopropanol. The ion bombardment 4 and/or the chemical etching 6 can be carried out continuously, possibly one directly after the other, the pre-etched strip of film 3 which has passed opposite the beam of ions being driven continuously in the corrosive solution. After neutralisation, rinsing and drying, a continuous film of microporous polymer material 7 is obtained.

In a variant embodiment of the chemical etching 6, a surfactant is added to the solution of soda in order to improve the wetting of the irradiated film 5 during the chemical etching 6. In a variant embodiment, an ultraviolet treatment 9 is carried out after ion bombardment 4 and before the chemical etching 6.

Reference is now made to FIGS. 2 and 3. The microporous polymer film 7 is subjected to an electrolysis 10. Then, by dissolving 11 the polymer matrix of the microporous film 7, metallic filaments 12 or polymers 14 are obtained. As stated above, the conventional implementation of the methods of chemical etching 6 of polymer films which have undergone an ion bombardment 4 results in the formation of pores with diameters which are variable from the surface to the heart of the film. The inventors carried out thorough investigations in order both to propose an explanation for this irregular shape of the pores and to propose a method for manufacturing microporous polymer films 7 in which the pores have a cylindrical shape overall and whose pores are smooth.

The experimental results obtained will be presented below with reference to embodiments of the invention and with reference to FIGS. 6 to 14. An initial film of PCa of Lexan™ make was subjected to a light pre-etching 2 Preal so as to remove a thickness of 0.5 microns on each face of the film. An initial film of PCa of Lexan™ make was subjected to an intense pre-etching Preal so as to remove a thickness of 2.0 microns on each face of the film. The thicknesses removed were measured by gravimetric analysis. The pre-etched films 3 were then subjected to an ion bombardment 4, at the Cyclotron Research Centre at Louvain-la-Neuve. Ar⁹⁺ ions were used at an acceleration voltage of 5.5 MeV/AMU. The bombarded films were then subjected to an ultraviolet radiation 9. The irradiated films 5 thus obtained were next subjected to a chemical etching 6 according to two modes:

a so-called “slow” chemical etching 6a, in a bath containing caustic soda at approximately 0.5 N in aqueous solution, at a temperature of approximately 70° C. for approximately 260 min;

a so-called “fast” chemical etching 6b, in a bath containing caustic soda at approximately 2 N in aqueous solution at a temperature of approximately 70° C. for approximately 30 min.

In the two cases of chemical etching 6a, 6b, a surfactant was added to the solution in order to increase the wetting of the irradiated film 5 during the etching. After the chemical etching 6a, 6b, the microporous films 7 obtained were washed: in an aqueous solution of acetic acid at approximately 15%, at a temperature of approximately 70° C., for approximately 15 minutes; then in demineralised water at a temperature of approximately 70° C. for approximately 15 minutes and more, until a neutral pH was obtained. The films were then coated with PVP in order to increase their hydrophilic character, then dried in warm air. The microporous films were then subjected to an electrolysis 10 performed in an electrochemical cell with three electrodes, at room temperature, such as a galvanoplasty cell, with a compartment made from Teflon™ with a counter-electrode made from platinum and a reference electrode made from calomel. A metallic twin layer 13, serving as electrodes, is applied to one of the faces of the microporous film 7. This twin layer 13 comprises: a first adhesion layer 13a of chromium, 10 to 20 nm thick, directly applied to one of the faces of the microporous film 7; a second layer 13b of gold, 500 nm to 1 micron thick, applied to the first layer 13a and in direct contact with the atmosphere.

The electrolysis 10 is carried out in the example embodiment which resulted in the filaments depicted in FIG. 12, with a solution comprising 0.1 M of pyrrole and 0.1 M of liclO₄[?], at a potential difference of +0.8 V. At the end of the galvanoplasty, the polycarbonate matrix of the microporous films is dissolved during step 11, in dichloromethane. The electrolysis 10 is carried out in the example embodiment which resulted in the filaments depicted in FIG. 5, with a solution comprising 50 g/l of CoSO₄ and 30 g/l of B(OH)₃, at a potential difference of −0.1 V. At the end of the galvanoplasty, the polycarbonate matrix of the microporous films is dissolved during step 11, in dichloromethane. The filaments obtained, depicted in FIG. 5, were filtered by means of a silver membrane.

The macroporous polymer films and the filaments obtained after step 11 were observed under a field-effect electron microscope (DSM 982 Gemini from the company Leo). Images with a satisfactory resolution were obtained for magnifications ranging up to 200,000, at an acceleration voltage of 400 V, without metallic deposition on the samples to be observed. The following parameters were measured:

mean diameter of the filaments, half-way along (MWD);

mean diameter of the pores on the surface of the microporous film 7 (MPS).

A calibration using nanospheres with a mean diameter of 30 nm (Calibrated nanospheres™ from Duke Scientific Corp.) was carried out in advance. By small-angle X-ray diffraction (SAXS), a measurement of the distribution of the sizes of pores contained in the microporous membranes 7 was carried out (E. Ferain, R. Legra, Nuclear Instruments and Methods in Physics Research B131, 1997, p. 97). An average pore size value (APS) and a standard deviation in the distribution of the pore diameters were derived from these measurements of intensity of the diffracted beam as a function of the diffraction angle.

The variations in the parameters MWD, MPS and APS defined above, as function of the chemical etching time 6, are depicted in FIGS. 6 and 7 for slow etching 6a (FIG. 6) and fast etching 6b (FIG. 7) of a PCc film of the Makrofol™ type. It is clear that:

the filaments obtained after step 11 have MWD diameters greater than the size of the pores on the surface of the microporous films 7, whether the etching be slow 6a or fast 6b and whatever the etching time in question, the filaments obtained have a toothpick shape as seen in FIG. 10;

the difference between the diameter values of the MWD filaments and the diameters of the pores on the surface of the film MPS is lower for the slow etching 6a than for the fast chemical etching 6b (approximately 15 nm as against approximately 30 nm);

the variations in the MPS and MWD values, as a function of the etching time, are similar, for a given type of etching 6a, 6b;

the average pore diameter values in the PCc film, after slow etching 6a, measured by SAXS, are between the values of the diameters of the filaments half-way along MWD and the values of the diameters of the pores on the surface of the film MPS.

The variations in the parameters MWD, MPS, as a function of the etching time, for a fast etching 6b of a PCa film of the Lexan™ type are shown in FIG. 8, for films which have undergone a light pre-etching Preal and for films which have not been pre-etched. It is clear that:

a light pre-etching Preal reduces the difference between the values of the diameters of the filaments MWD and the values of the diameters MPS of the pores on the surface, compared with a non pre-etched film (approximately 30 nm as against approximately 10 nm);

the pre-etching does not modify the rate of variation in MPS or MWD as a function of the etching time.

The variations in the parameters MWD, MPS and APS, as a function of the etching time, for a slow etching 6a of a PCa film of the Lexan™ type, are shown in FIG. 9, for films which have undergone an intense pre-etching Preai. It is clear that the values of the parameters MWD, MPS and APS are substantially merged, for the range of slow etching times 6a in question, so that the pores formed in the film can be considered to be cylindrical.

The polypyrrole filaments obtained after electrolytic deposition 10 in the pores of a PCa film which has undergone an intense pre-etching 2 Preai and dissolving 11 of this film in polycarbonate also have a very regular cylindrical shape, as is clear in FIG. 12. The filaments obtained from PCa show a lower roughness (FIG. 11b) than those obtained from PCc (FIG. 11a), as is clear in FIG. 11. This observation must probably be correlated with the amorphous character of the PCa films of the Lexan™ type used here, resulting in irregularities in the chemical etching paths forming the pores, and with the semicrystalline character of the PCc films of the Makrofol™ type, the crystallites of the Makrofol™ films resulting in irregularities in the chemical etching fields forming the pores. The pores obtained for PCa films which have undergone an intense pre-etching 2 Preai exhibit average diameter distributions with smaller standard deviations than those obtained for the pores of the PCc films, as is clear in FIG. 13.

As shown in FIG. 14, the losses of thickness measured by gravimetric analysis, for increasing etching times of PCa, PCc and strongly pre-etched PCa films, not subjected to ion bombardment 4, are substantially identical for the first two microns of thickness of the films. Consequently, there do not appear to exist surface layers more resistant to chemical etching 6, contrary to the hypotheses sometimes adopted in the literature.

Overall, the experimental results presented above made it possible to establish a high positive influence of a pre-etching 2 of the films 1 before ion bombardment 4, this pre-etching 2 making it possible to obtain pores which are substantially cylindrical rather than in the shape of “toothpicks” or “cigars” as in the prior methods. The precise origin of this influence of the pre-etching 2 remains indeterminate. The geometry of the pores obtained makes it possible to produce nanofilaments or nanotubes of metal 12 or polymer 14, these filaments 12, 14 being able to have a smooth surface and a cylindrical shape over lengths varying between a few nanometers and several tens of microns. Such nanofilaments or nanotubes are of very great interest for electronic, optical or biomedical applications for example. Moreover, the precise control of the three-dimensional porosity in polymer films makes it possible to produce filters which are very useful in medical fields or in water treatment.

1. A method for creating nanoscale pores in a sheet polymer material comprising an ion bombardment, wherein a pre-etching is carried out prior to the ion bombardment and reduces the thickness of the sheet of polymer material.

2. The method according to claim 1, wherein the polymer material is selected from the group of saturated polyesters such as ethylene polyterephthalate, carbonic acid polyesters such as polycarbonate produced from bis-phenol A (bis(hydroxy-4 phenol)-2.2 propane), aromatic polyethers, polysulphones, polyolefins, cellulose acetates and cellulose nitrates.

3. The method according to claim 1, wherein the sheet of polymer material has, before pre-etching, a thickness of between a few hundreds of nanometers and around a hundred microns.

4. The method according to claim 3, wherein the pre-etching is carried out until the ablation of a thickness which may attain as much as 3 microns on each face of the said sheet.

5. The method according to claim 1, wherein the polymer material is an amorphous or crystalline polycarbonate.

6. The method according to claim 5, wherein the polymer material is an amorphous polycarbonate with a thickness of approximately 25 microns before pre-etching.

7. The method according to claim 5, wherein the polymer material is a crystalline polycarbonate with a thickness of approximately 10 microns before pre-etching.

8. The method according to claim 1, further comprising an ultraviolet treatment carried out after the ion bombardment and before the chemical etching.

9. The method according to claim 1, wherein the ion bombardment is carried out by a beam of ions preferably issuing from rare gases such as argon, with an energy of around 2 MeV per nucleon, the density of ions passing through the polymer film being between 10⁴ and 10¹³ ions per square centimeter.

10. The method according to claim 1, wherein the chemical etching is said to be slow and is carried out in a bath containing caustic soda at approximately 0.5 N in aqueous solution, at a temperature of approximately 70° C. for approximately 260 min.

11. The method according to claim 1, wherein the chemical etching is said to be fast and is carried out in a bath containing caustic soda at approximately 2N, in aqueous solution, at a temperature of approximately 70° C., for approximately 30 min.

12. The method according to claim 10, wherein the chemical etching bath comprises an organic solvent.

13. The method according to claim 11, wherein the chemical etching bath comprises an organic solvent.

14. The method according to claim 12, wherein the organic solvent is selected from the group of methanol, ethanol and isopropanol.

15. The method according to claim 10, wherein the chemical etching is carried out in the presence of a surfactant.

16. The method according to claim 6, further comprising microporous films obtained after chemical etching, the microporous films being washed until neutralisation of the pH, rinsed and dried.

17. The method according to claim 16, wherein the washing of the microporous films is carried out in an aqueous solution of acetic acid at approximately 15%, at a temperature of approximately 70° C. for approximately 15 minutes; then in demineralised water, at a temperature of approximately 70° C., for approximately 15 minutes and more, until a neutral pH is obtained.

18. The method according to claim 1 being carried out continuously.

19. A microporous film of polymer material produced by implementing the method according to claim 1, wherein the film is used as a matrix for various applications including the production of micrometric filaments selected from the group of metal and polymer.

20. A microporous film of polymer material produced by implementing the method according to claim 1 wherein the film is used as a filter for various applications including the production of micrometric filaments selected from the group of metal and polymer.
